(19) United States
(12) Patent Application Publication
(10) Pub. No.: US 2016/0334916 A1
(43) Pub. Date: Nov. 17, 2016

(54) IN-CELL TOUCH SCREEN AND A METHOD OF DRIVING THE SAME

(71) Applicant: HIMAX TECHNOLOGIES LIMITED, Tainan City (TW)

(72) Inventors: Guan-Ying Huang, Tainan City (TW); Wei-Song Wang, Tainan City (TW); Yaw-Guang Chang, Tainan City (TW)

(21) Appl. No.: 14/827,156

(22) Filed: Aug. 14, 2015

Related U.S. Application Data
(60) Provisional application No. 62/160,948, filed on May 13, 2015.
(60) Provisional application No. 62/189,033, filed on Jul. 6, 2015.

(51) Int. Cl. G06F 3/041; G06F 3/044

(52) U.S. Cl. CPC G06F 3/0416; G06F 3/0412; G06F 3/044

(57) ABSTRACT

The present invention is directed to a method of driving an in-cell touch screen. In one embodiment, adjacent common voltage (VCOM) electrodes, a source line and/or a gate line is set high-impedance, such that an equivalent capacitor is not possessed by the current VCOM electrode. In another embodiment, a gate line is set high-impedance in the touch sensing mode. A voltage waveform of the current VCOM electrode is applied to adjacent VCOM electrodes abutting the current VCOM electrode and/or to a source line, such that an equivalent capacitor has no effect on the current VCOM electrode.

### CROSS-REFERENCE TO RELATED APPLICATIONS

This application claims the benefit of U.S. Provisional Application No. 62/160,948, filed on May 13, 2015, and U.S. Provisional Application No. 62/189,033, filed on Jul. 6, 2015, the entire contents of which are hereby expressly incorporated by reference.

### BACKGROUND OF THE INVENTION

1. Field of the Invention

The present invention generally relates to a touch screen, and more particularly to an in-cell touch screen.

2. Description of Related Art

A touch screen is an input/output device that combines touch technology and display technology to enable users to directly interact with what is displayed. A capacitor-based touch panel is a commonly used touch panel that utilizes capacitive coupling effect to detect touch position. Specifically, capacitance corresponding to the touch position changes and is thus detected, when a finger touches a surface of the touch panel.

In order to produce thinner touch screens, in-cell technology has been adopted that eliminates one or more layers by building capacitors inside the display. Conventional in-cell touch screens, however, possesses substantive parasitic capacitors that form a large load, thereby affecting sensitivity of the touch screen. Accordingly, a need has arisen to propose a novel scheme for driving an in-cell touch screen with enhanced touch sensitivity.

### SUMMARY OF THE INVENTION

In view of the foregoing, it is an object of the embodiment of the present invention to provide a method of driving an in-cell touch screen in order to reduce capacitance of the parasitic capacitors, or to reduce power consumption.

According to one embodiment, a touch screen has a common voltage (VCOM) layer divided into VCOM electrodes which act as sensing points in a touch sensing mode. In one embodiment, adjacent VCOM electrodes abutting a current VCOM electrode, a source line underlying the current VCOM electrode, and/or a gate line underlying the current VCOM electrode is set high-impedance in the touch sensing mode, such that an equivalent capacitor is not possessed by the current VCOM electrode, thereby substantially reducing a load at the sensing point. In another embodiment, a gate line underlying a current VCOM electrode is set high-impedance in the touch sensing mode. A voltage waveform of the current VCOM electrode is applied to adjacent VCOM electrodes abutting the current VCOM electrode and/or to a source line underlying the current VCOM electrode, such that an equivalent capacitor has no effect on the current VCOM electrode, thereby substantially reducing a load at the sensing point.

### BRIEF DESCRIPTION OF THE DRAWINGS

FIG. 1 schematically shows a perspective view of a capacitive in-cell touch screen according to an embodiment of the present invention;

FIG. 2 shows the VCOM layer of FIG. 1;

FIG. 3 shows a circuit diagram illustrating equivalent capacitors among the VCOM electrodes, the source lines and the gate lines of FIG. 1;

FIG. 4 shows a circuit diagram illustrating equivalent capacitors among the VCOM electrodes, the source lines and the gate lines according to a first embodiment of the present invention;

FIG. 5 shows a circuit diagram illustrating equivalent capacitors among the VCOM electrodes, the source lines and the gate lines according to a second embodiment of the present invention;

FIG. 6 shows voltage waveforms of a current VCOM electrode and the underlying source line according to a third embodiment of the present invention;

FIG. 7 shows voltage waveforms of a current VCOM electrode and the underlying source line according to a fourth embodiment of the present invention;

FIG. 8 shows voltage waveforms of a current VCOM electrode and the underlying source line according to a fifth embodiment of the present invention;

FIG. 9 shows voltage waveforms of a current VCOM electrode and the underlying source line according to a sixth embodiment of the present invention;

FIG. 10 shows a circuit diagram illustrating equivalent capacitors among the VCOM electrodes, the source lines and the gate lines of FIG. 1;

FIG. 11 shows a circuit diagram illustrating equivalent capacitors among the VCOM electrodes, the source lines and the gate lines according to a seventh embodiment of the present invention; and

FIG. 12A, FIG. 12B and FIG. 12C show voltage waveforms of VCOM electrodes, the underlying source line and the underlying gate line.

### DETAILED DESCRIPTION OF THE INVENTION

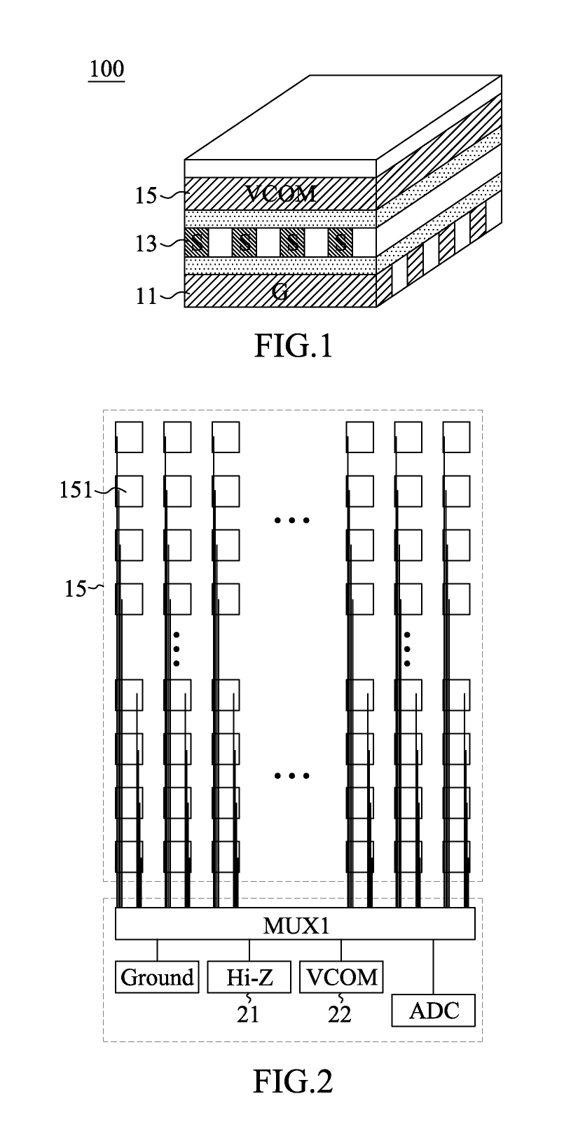

FIG. 1 schematically shows a perspective view of a capacitive in-cell touch screen 100 according to an embodiment of the present invention. The self-capacitance in-cell touch screen (hereinafter touch screen) 100 primarily includes, from bottom up, gate (G) lines 11, source (S) lines 13 and a common voltage (VCOM) layer 15, which are isolated from each other. For brevity, some components of the touch screen 100 are not shown. For example, a liquid crystal layer may be disposed above the VCOM layer 15.

Specifically, gate lines 11 are disposed latitudinally or in rows, and source lines 13 are disposed longitudinally or in columns. The VCOM layer 15 is divided into VCOM electrodes 151 as exemplified in FIG. 2, which act as sensing points (or receiving (RX) electrodes) in a touch sensing mode, and the VCOM electrodes 151 are connected to a common voltage, e.g., a direct-current (DC) voltage, in a display mode.

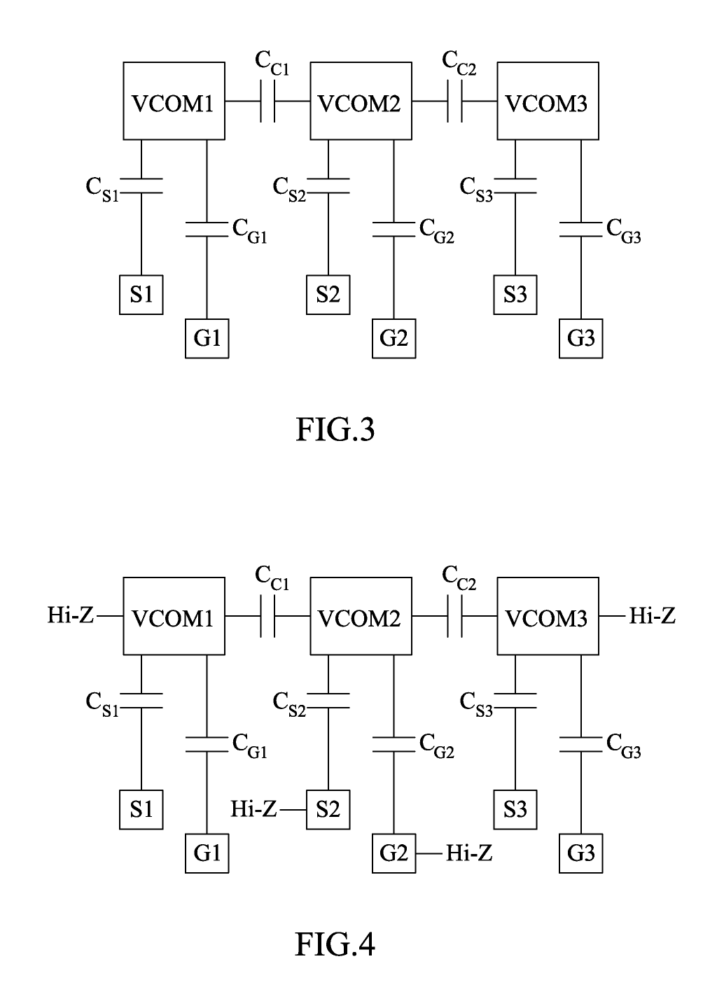

As the VCOM electrodes 151, the source lines 13 and the gate lines 11 are close to each other for a compact touch screen 100, parasitic capacitors are possessed by the touch screen 100. FIG. 3 shows a circuit diagram illustrating equivalent capacitors among the VCOM electrodes 151, the source lines 13 and the gate lines 11. VCOM1, VCOM2 and VCOM3 represent three adjacent VCOM electrodes 151. C_{C1} and C_{C2} represent equivalent capacitors between the VCOM electrodes 151. C_{S1}, C_{S2} and C_{S3} represent equivalent capacitors between the VCOM electrodes 151 (i.e., VCOM1, VCOM2 and VCOM3) and underlying source lines 13, respectively. C_{G1}, C_{G2} and C_{G3} represent equivalent capacitors between the VCOM electrodes 151 (i.e., VCOM1, VCOM2 and VCOM3) and underlying gate lines 11, respectively. Each sensing point (or VCOM electrodes 151) possesses a total capacitance of (C_{CX}+C_{SX}+C_{GX}) (where X is 1, 2, or 3), which results in a load that affects sensitivity of the touch screen 100. In order to reduce capacitance of the parasitic capacitors, some embodiments are thus proposed.

FIG. 4 shows a circuit diagram illustrating equivalent capacitors among the VCOM electrodes 151, the source lines 13 and the gate lines 11 according to a first embodiment of the present invention. In the embodiment, VCOM1, VCOM2 and VCOM3 are under touch sensing in turn. When a current VCOM electrode 151 (e.g., VCOM2) is currently under touch sensing, adjacent VCOM electrodes 151 (e.g., VCOM1 and VCOM3) are set high-impedance (Hi-Z) or floating, for example, by a high-impedance unit 21 shown in FIG. 2. Further, the source line 13 (e.g., S2) underlying the current VCOM electrode 151 and the gate line 11 (e.g., G2) underlying the current VCOM electrode 151 are set high-impedance (Hi-Z) or floating. Accordingly, the equivalent capacitors C_{C1}, C_{C2}, C_{S2} and C_{G2} are no longer possessed by the current VCOM electrode 151 (or the sensing point), thereby substantially reducing the load at the sensing point.

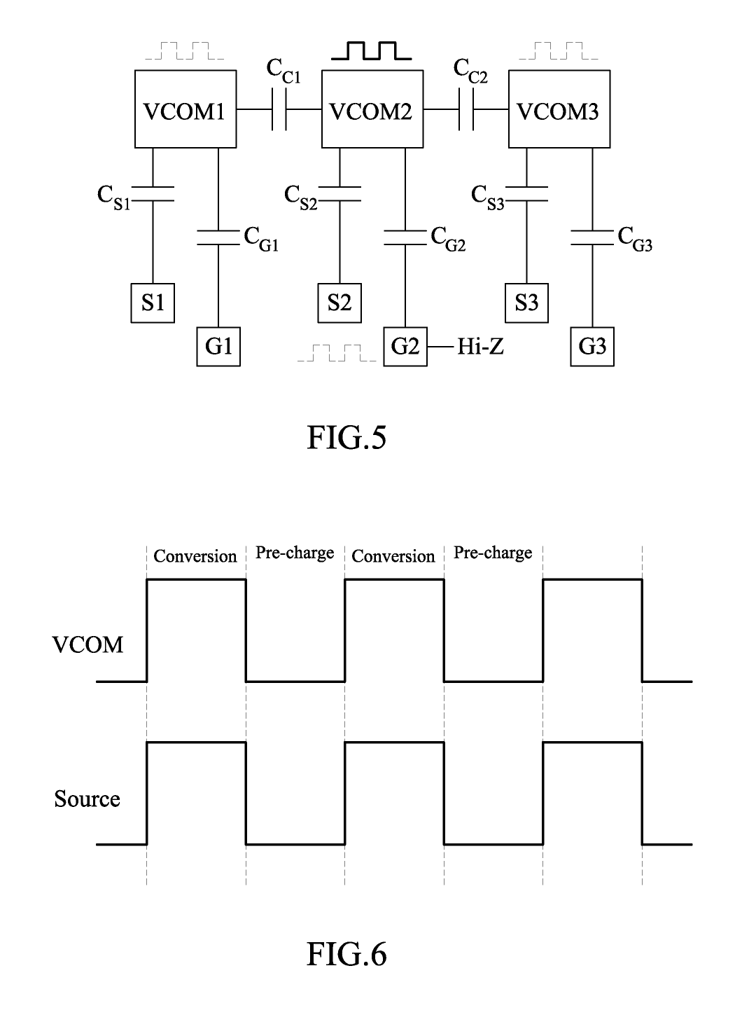

FIG. 5 shows a circuit diagram illustrating equivalent capacitors among the VCOM electrodes 151, the source lines 13 and the gate lines 11 according to a second embodiment of the present invention. In the embodiment, VCOM1, VCOM2 and VCOM3 are under touch sensing in turn. When a current VCOM electrode 151 (e.g., VCOM2) is currently under touch sensing, a voltage waveform at the current VCOM electrode 151 is applied to adjacent VCOM electrodes 151 (e.g., VCOM1 and VCOM3), for example, by a VCOM unit 22 shown in FIG. 2. Accordingly, the adjacent VCOM electrodes 151 and the current VCOM electrode 151 operate simultaneously. The voltage waveform at the current VCOM electrode 151 is also applied to the source line 13 (e.g., S2) underlying the current VCOM electrode 151. Accordingly, the current VCOM electrode 151 and the underlying source line 13 operate simultaneously. As two ends of an equivalent capacitor (e.g., C_{C1}, C_{C2} or C_{S2}) have the same voltage waveform or operates simultaneously, the equivalent capacitor therefore has no effect on the current VCOM electrode 151 (or the sensing point). Further, the gate line 11 (e.g., G2) underlying the current VCOM electrode 151 is set high-impedance (Hi-Z) or floating. Accordingly, the equivalent capacitor C_{G2} is no longer possessed by the current VCOM electrode 151 (or the sensing point), thereby substantially reducing the load at the sensing point.

FIG. 6 shows voltage waveforms of a current VCOM electrode 151 and the underlying source line 13 according to a third embodiment of the present invention. In this embodiment, the voltage waveform of the current VCOM electrode 151 is applied to the underlying source line 13 during a conversion phase and a pre-charge phase, which compose a sensing period.

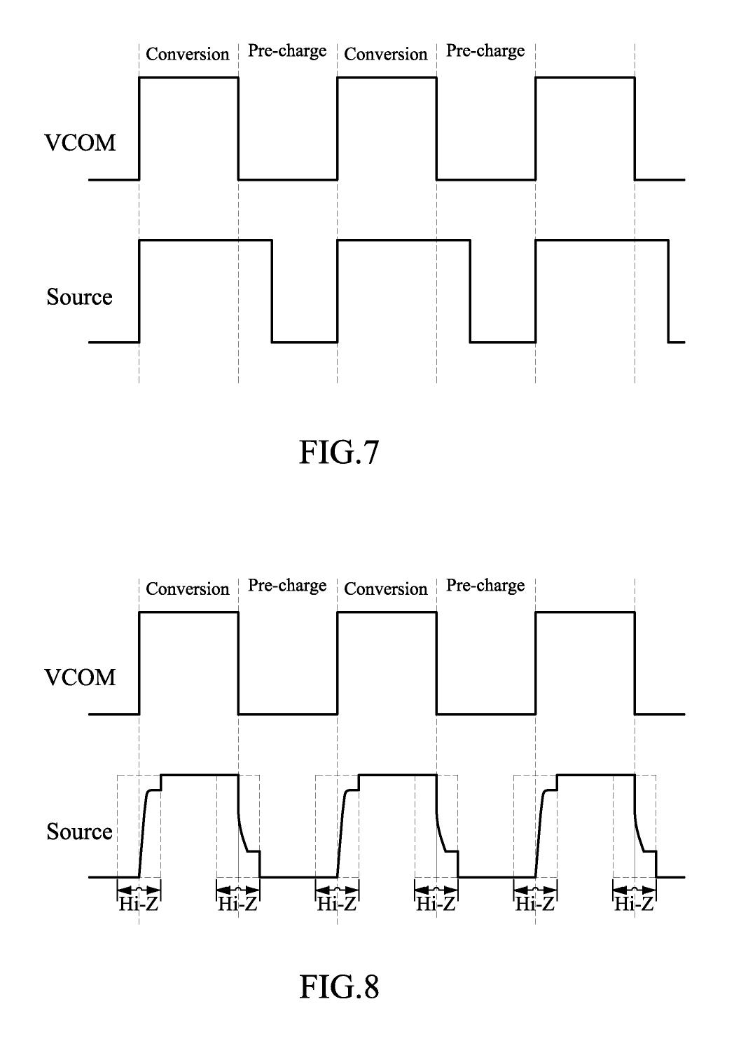

In practice, the equivalent capacitor due to the source line 13 has effect on touch sensing result only in the conversion, but has no effect on the touch sensing result in the pre-charge phase. Accordingly, as shown in FIG. 7, a fourth embodiment of the present invention, the voltage waveform of the current VCOM electrode 151 is applied to the underlying source line 13 only during a conversion phase.

FIG. 8 shows voltage waveforms of a current VCOM electrode 151 and the underlying source line 13 according to a fifth embodiment of the present invention. In the embodiment, the voltage waveform of the current VCOM electrode 151 is applied to the underlying source line 13 only when the voltage waveform becomes stable in the conversion phase and the pre-charge phase. During sub-periods when the voltage waveform is not stable or sub-periods of transition (from high level to low level or from low level to high level), the source line 13 (e.g., S2) underlying the current VCOM electrode 151 is set high-impedance (Hi-Z) or floating, thereby reducing power consumption. It is noted that, during the sub-periods of transition, the voltage at the source line 13 may be pulled up or down via the equivalent capacitor (e.g., C_{S2}).

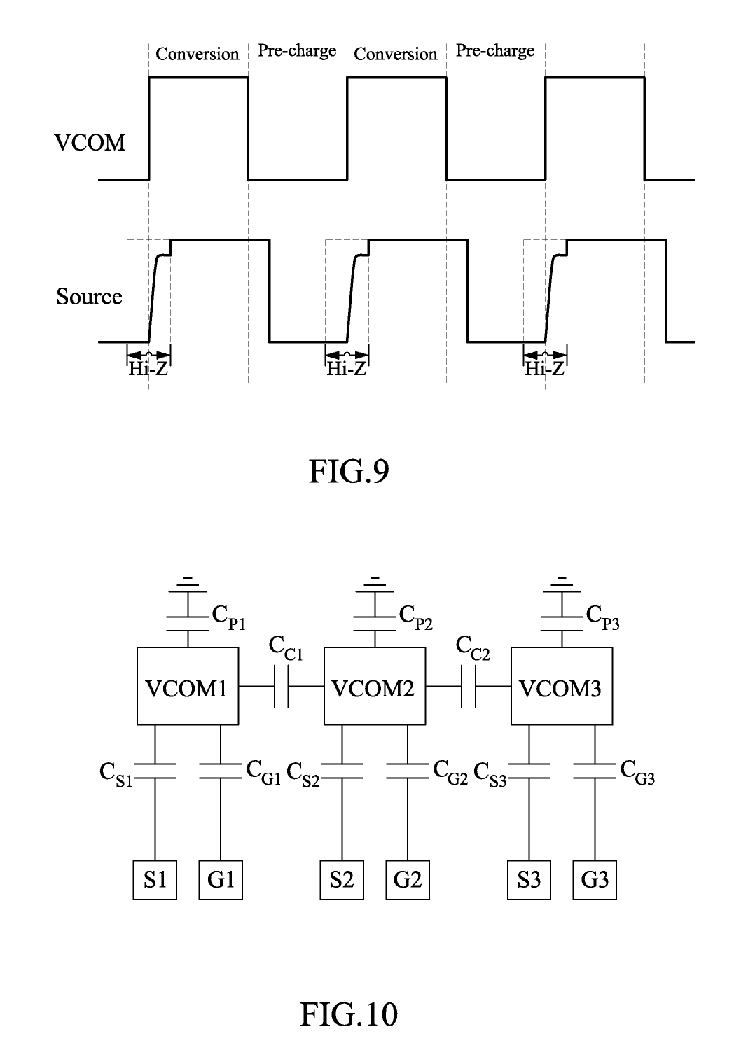

As described above that the equivalent capacitor due to the source line 13 has effect on touch sensing result only in the conversion, the voltage waveform of the current VCOM electrode 151 is applied to the underlying source line 13 only when the voltage waveform becomes stable in the conversion phase, as shown in FIG. 9, a sixth embodiment of the present invention. During sub-periods when the voltage waveform is not stable or sub-periods of transition, the source line 13 (e.g., S2) underlying the current VCOM electrode 151 is set high-impedance (Hi-Z) or floating, thereby reducing power consumption. Similar to the fifth embodiment (FIG. 8), during the sub-periods of transition, the voltage at the source line 13 may be pulled up via the equivalent capacitor (e.g., C_{S2}).

FIG. 10 shows a circuit diagram illustrating equivalent capacitors among the VCOM electrodes 151, the source lines 13 and the gate lines 11. VCOM1, VCOM2 and VCOM3 represent three adjacent VCOM electrodes 151. C_{C1} and C_{C2} represent equivalent capacitors between the VCOM electrodes 151. C_{S1}, C_{S2} and C_{S3} represent equivalent capacitors between the VCOM electrodes 151 (i.e., VCOM1, VCOM2 and VCOM3) and underlying source lines 13, respectively. C_{G1}, C_{G2} and C_{G3} represent equivalent capacitors between the VCOM electrodes 151 (i.e., VCOM1, VCOM2 and VCOM3) and underlying gate lines 11, respectively. C_{P1}, C_{P2} and C_{P3} represent equivalent capacitors pertaining to the VCOM electrodes 151 (i.e., VCOM1, VCOM2 and VCOM3) caused by other than the source lines 13 and the gate lines 11. Each sensing point (or VCOM electrodes 151) possesses a total capacitance of (C_{CX}+C_{SX}+C_{GX}+C_{PX}) (where X is 1, 2, or 3), which results in a load that affects sensitivity of the touch screen 100. In order to reduce capacitance of the parasitic capacitors, further embodiments are thus proposed.

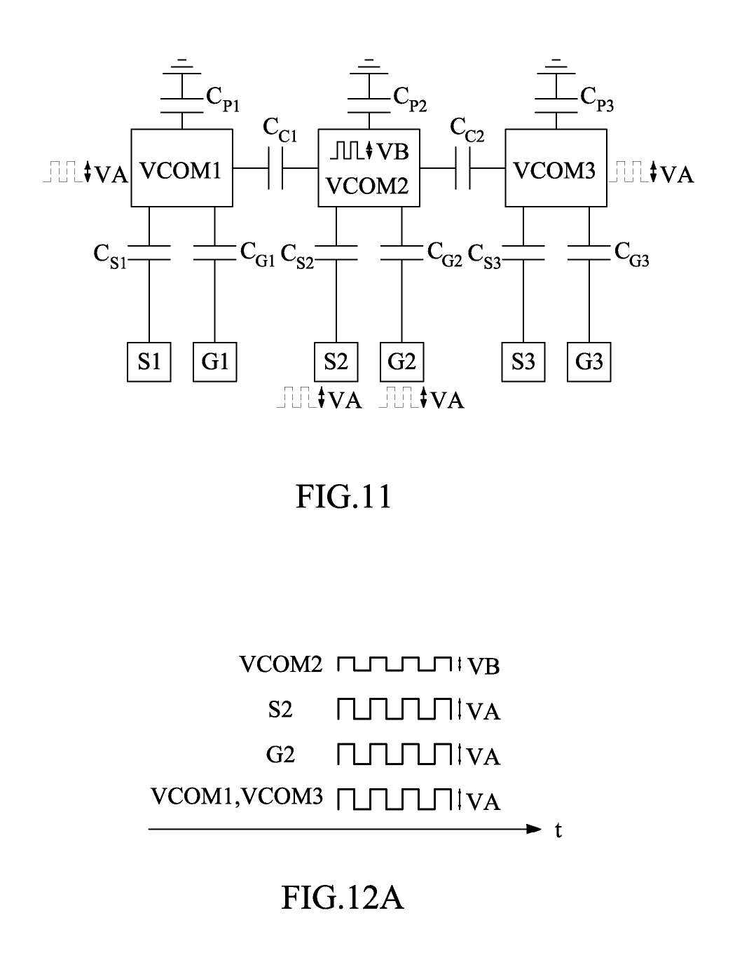

FIG. 11 shows a circuit diagram illustrating equivalent capacitors among the VCOM electrodes 151, the source lines 13 and the gate lines 11 according to a seventh embodiment of the present invention. In the embodiment, VCOM1, VCOM2 and VCOM3 are under touch sensing in turn. When a current VCOM electrode 151 (e.g., VCOM2) is currently under touch sensing having a voltage waveform with a first amplitude VB, the same voltage waveform with a second amplitude VA is applied to adjacent VCOM electrodes 151 (e.g., VCOM1 and VCOM3), for example, by a VCOM unit 22 shown in FIG. 2. The same voltage waveform with the second amplitude VA is also applied to the source line 13 (e.g., S2) and the gate line 11 (e.g., G2) underlying the current VCOM electrode 151.

Let Q_{C1} represents the charge contributed to the VCOM electrode 151 by the equivalent capacitor C_{C1}, Q_{C2} represents the charge contributed to the VCOM electrode 151 by the equivalent capacitor C_{C2}, Q_{S2} represents the charge contributed to the VCOM electrode 151 by the equivalent capacitor C_{S2}, Q_{G2} represents the charge contributed to the VCOM electrode 151 by the equivalent capacitor C_{G2}, Q_{P2} represents the charge contributed to the VCOM electrode 151 by the equivalent capacitor C_{P2}, and Qₜₒₜₐₗ total represents the charge contributed to the VCOM electrode 151 by the total capacitance (C_{C1}+C_{C2}+C_{S2}+C_{G2}+C_{P2}):

Q_{C1}=(VB−VA)*C_{C1}

Q_{C2}=(VB−VA)*C_{C2}

Q_{S2}=(VB−VA)*C_{S2}

Q_{G2}=(VB−VA)*C_{G2}

Q_{P2}=VB*C_{P2}

Qₜₒₜₐₗ=Q_{C1}+Q_{C2}+Q_{S2}+Q_{G2}+Q_{P2}

It is noted that, if the second amplitude VA is greater than the first amplitude VB (i.e., VA>VB), the charges Q_{C1}, Q_{C2}, Q_{S2} and Q_{G2} are inverse to the charge Q_{P2}, thereby compensating for the effects caused by Q_{P2}.

The present embodiment is more useable when multiple channels are sensed concurrently, in that case the equivalent capacitor C_{P2} (that is, the equivalent capacitors pertaining to the VCOM electrodes 151 caused other than the source lines 13 and the gate lines 11) predominates with greater effects on the touch sensitivity.

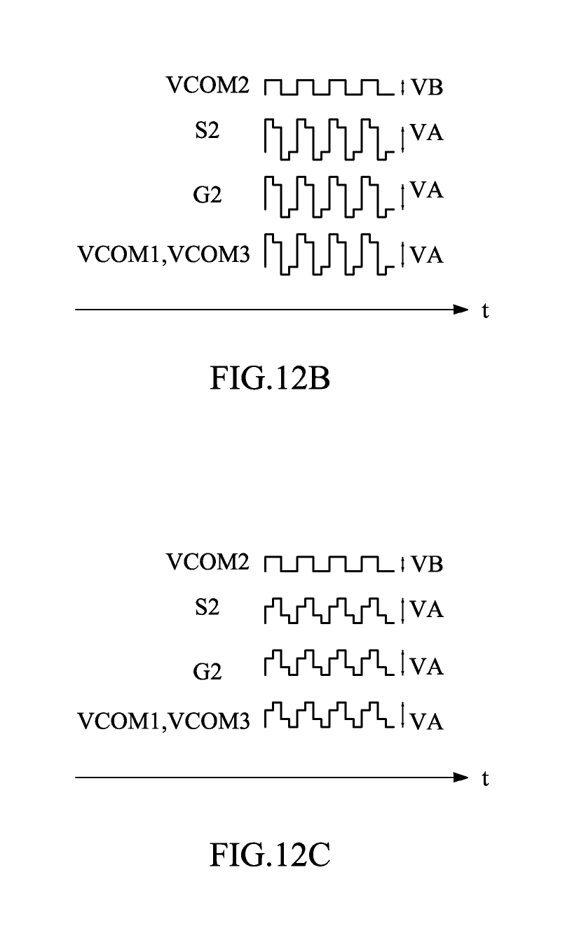

FIG. 12A, FIG. 12B and FIG. 12C show voltage waveforms of VCOM electrodes 151, the underlying source line 13 (e.g., S2) and the underlying gate line 11 (e.g., G2). It is observed in FIG. 12A that the voltage waveform applied to the underlying source line 13 (e.g., S2), the underlying gate line 11 (e.g., G2) and the adjacent

VCOM electrodes 151 (e.g., VCOM1 and VCOM3) has a fixed amplitude (i.e., the second amplitude VA) during a conversion phase. However, in FIG. 12B, the applied voltage waveform overdrives before settling on the second amplitude VA in the conversion phase and the pre-charge phase. Alternatively, in FIG.

12C, the applied voltage waveform underdrives before settling on the second amplitude VA in the conversion phase and the pre-charge phase.

Although specific embodiments have been illustrated and described, it will be appreciated by those skilled in the art that various modifications may be made without departing from the scope of the present invention, which is intended to be limited solely by the appended claims.

What is claimed is:

1. A method of driving an in-cell touch screen, comprising:
providing a touch screen with a common voltage (VCOM) layer divided into VCOM electrodes which act as sensing points in a touch sensing mode; and
setting adjacent VCOM electrodes abutting a current VCOM electrode, a source line underlying the current VCOM electrode, and/or a gate line underlying the current VCOM electrode high-impedance in the touch sensing mode, such that an equivalent capacitor is not possessed by the current VCOM electrode, thereby substantially reducing a load at the sensing point.

2. The method of claim 1, wherein the adjacent VCOM electrodes abutting the current VCOM electrode are set high-impedance, the source line underlying the current VCOM electrode is set high-impedance, and the gate line underlying the current VCOM electrode is set high-impedance.

3. The method of claim 1, wherein the in-cell touch screen comprises a self-capacitance in-cell touch screen.

4. The method of claim 1, wherein the VCOM electrodes are connected to a common voltage in a display mode.

5. A method of driving an in-cell touch screen, comprising:
providing a touch screen with a common voltage (VCOM) layer divided into VCOM electrodes which act as sensing points in a touch sensing mode;
setting a gate line underlying a current VCOM electrode high-impedance in the touch sensing mode; and
applying a voltage waveform of the current VCOM electrode to adjacent VCOM electrodes abutting the current VCOM electrode and/or to a source line underlying the current VCOM electrode, such that an equivalent capacitor has no effect on the current VCOM electrode, thereby substantially reducing a load at the sensing point.

6. The method of claim 5, wherein the in-cell touch screen comprises a self-capacitance in-cell touch screen.

7. The method of claim 5, wherein the VCOM electrodes are connected to a common voltage in a display mode.

8. The method of claim 5, wherein the voltage waveform of the current VCOM electrode is applied during both a conversion phase and a pre-charge phase of a sensing period.

9. The method of claim 8, wherein the voltage waveform of the current VCOM electrode is applied only when the voltage waveform becomes stable in the conversion phase and the pre-charge phase.

10. The method of claim 9, wherein the source line underlying the current VCOM electrode is set high-impedance during sub-periods of transition.

11. The method of claim 5, wherein the voltage waveform of the current VCOM electrode is applied during only a conversion phase of a sensing period.

12. The method of claim 11, wherein the source line underlying the current VCOM electrode is set high-impedance during sub-periods of transition from low level to high level.

13. A method of driving an in-cell touch screen, comprising:
providing a touch screen with a common voltage (VCOM) layer divided into VCOM electrodes which act as sensing points in a touch sensing mode;
applying a voltage waveform of a current VCOM electrode to adjacent VCOM electrodes abutting the current VCOM electrode, to a gate line underlying the current VCOM electrode and to a source line underlying the current VCOM electrode, such that an equivalent capacitor has no effect on the current VCOM electrode, thereby substantially reducing a load at the sensing point;
wherein the applied voltage waveform has an amplitude larger than a voltage waveform at the current VCOM electrode.

14. The method of claim 13, wherein the in-cell touch screen comprises a self-capacitance in-cell touch screen.

15. The method of claim 13, wherein the VCOM electrodes are connected to a common voltage in a display mode.

16. The method of claim 13, wherein the applied voltage waveform has a fixed amplitude during a conversion phase.

17. The method of claim 13, wherein the applied voltage waveform overdrives before settling on a predetermined amplitude in the conversion phase and the pre-charge phase.

18. The method of claim 13, wherein the applied voltage waveform underdrives before settling on a predetermined amplitude in the conversion phase and the pre-charge phase.

19. An in-cell touch screen, comprising:
gate lines disposed latitudinally;
source lines disposed longitudinally; and
a common voltage (VCOM) layer divided into VCOM electrodes which act as sensing points in a touch sensing mode, and are connected to a common voltage in a display mode;
wherein adjacent VCOM electrodes abutting a current VCOM electrode, a source line underlying the current VCOM electrode, and/or a gate line underlying the current VCOM electrode is set high-impedance in the touch sensing mode, such that an equivalent capacitor is not possessed by the current VCOM electrode, thereby substantially reducing a load at the sensing point.

20. The in-cell touch screen of claim 19, wherein the gate lines, the source lines and the VCOM layer are disposed in sequence, and are electrically isolated from each other.

21. The in-cell touch screen of claim 19, wherein the in-cell touch screen comprises a self-capacitance in-cell touch screen.

22. An in-cell touch screen, comprising:
gate lines disposed latitudinally;
source lines disposed longitudinally;
a common voltage (VCOM) layer divided into VCOM electrodes which act as sensing points in a touch sensing mode, and are connected to a common voltage in a display mode;
wherein a gate line underlying a current VCOM electrode is set high-impedance in the touch sensing mode; and
a voltage waveform of the current VCOM electrode is applied to adjacent VCOM electrodes abutting the current VCOM electrode and/or to a source line underlying the current VCOM electrode, such that an equivalent capacitor has no effect on the current VCOM electrode, thereby substantially reducing a load at the sensing point.

23. The in-cell touch screen of claim 22, wherein the gate lines, the source lines and the VCOM layer are disposed in sequence, and are electrically isolated from each other.

24. The in-cell touch screen of claim 22, wherein the in-cell touch screen comprises a self-capacitance in-cell touch screen.

25. The in-cell touch screen of claim 22, wherein the voltage waveform of the current VCOM electrode is applied during both a conversion phase and a pre-charge phase of a sensing period.

26. The in-cell touch screen of claim 25, wherein the voltage waveform of the current VCOM electrode is applied only when the voltage waveform becomes stable in the conversion phase and the pre-charge phase.

27. The in-cell touch screen of claim 26, wherein the source line underlying the current VCOM electrode is set high-impedance during sub-periods of transition.

28. The in-cell touch screen of claim 22, wherein the voltage waveform of the current VCOM electrode is applied during only a conversion phase of a sensing period.

29. The in-cell touch screen of claim 28, wherein the source line underlying the current VCOM electrode is set high-impedance during sub-periods of transition from low level to high level.

30. An in-cell touch screen, comprising:
gate lines disposed latitudinally;
source lines disposed longitudinally;
a common voltage (VCOM) layer divided into VCOM electrodes which act as sensing points in a touch sensing mode, and are connected to a common voltage in a display mode;
wherein a voltage waveform of a current VCOM electrode is applied to adjacent VCOM electrodes abutting the current VCOM electrode, to a gate line underlying the current VCOM electrode and to a source line underlying the current VCOM electrode, such that an equivalent capacitor has no effect on the current VCOM electrode, thereby substantially reducing a load at the sensing point;
wherein the applied voltage waveform has an amplitude larger than a voltage waveform at the current VCOM electrode.

31. The in-cell touch screen of claim 30, wherein the gate lines, the source lines and the VCOM layer are disposed in sequence, and are electrically isolated from each other.

32. The in-cell touch screen of claim 30, wherein the in-cell touch screen comprises a self-capacitance in-cell touch screen.

33. The in-cell touch screen of claim 30, wherein the applied voltage waveform has a fixed amplitude during a conversion phase.

34. The in-cell touch screen of claim 30, wherein the applied voltage waveform overdrives before settling on a predetermined amplitude in the conversion phase and the pre-charge phase.

35. The in-cell touch screen of claim 30, wherein the applied voltage waveform underdrives before settling on a predetermined amplitude in the conversion phase and the pre-charge phase.
